(19) United States
(12) Patent Application Publication
(10) Pub. No.: US 2010/0319535 A1
(43) Pub. Date: Dec. 23, 2010

(54) HIGH-TEMPERATURE, STEAM-SELECTIVE MEMBRANE

(76) Inventors: Ashok V. Joshi, Salt Lake City, UT (US); Feng Zhao, Salt Lake City, UT (US)

Correspondence Address: CERAMATEC, INC., 2425 SOUTH 900 WEST, SALT LAKE CITY, UT, 84119, US

(21) Appl. No.: 12/818,673

(22) Filed: Jun. 18, 2010

Related U.S. Application Data
(60) Provisional application No. 61/219,564, filed on Jun. 23, 2009.

(51) Int. Cl. B01D 53/22

(52) U.S. Cl. 95/52; 96/11

(57) ABSTRACT

A high-temperature, steam-selective membrane for adding steam to or removing steam from various types of chemical reactions is disclosed herein. In one embodiment, such a membrane includes a polymer layer (a Nafion or sulfonated PEEK polymer layer, for example) exhibiting high selectivity to the transport of steam relative to other gas species. The polymer layer is sandwiched between substantially rigid porous layers that are steam permeable. The rigid porous layers substantially immobilize the polymer layer and reduce the tendency of the polymer layer to shrink and/or expand in response to changes in temperature or humidity. The rigid porous layers may also retain water to keep the polymer layer moist. The physical support and moisture retention provided by the rigid porous layers enable the polymer layer to operate in a temperature range of about 100° C. to 500° C.

### RELATED APPLICATIONS

This application claims priority to U.S. Provisional Patent No. 61/219,564 filed on Jun. 23, 2009 and entitled A STEAM PERMEABLE MEMBRANE WITH HIGH SELECTIVITY.

### BACKGROUND OF THE INVENTION

1. Field of the Invention

This invention relates to apparatus and methods for selectively adding steam to or removing steam from different chemical reactions.

2. Background

In many chemical reactions, steam is either a reactant or product. As dictated by equilibrium thermodynamics and/or to improve the kinetics of the chemical reactions, chemical reactions that either produce or consume steam typically occur at temperatures above 100° C. For example, in a conventional steam reformation process, steam is reacted with methane to produce carbon monoxide and hydrogen gas at temperatures between 600° C. and 800° C. Similarly, in a conventional Fischer-Tropsch process, hydrogen and carbon monoxide are reacted at 250° C. to generate hydrocarbons which are then used to produce synthetic liquid fuels. Steam is a byproduct of the reaction.

Other non-limiting examples of either steam-producing or steam-consuming chemical reactions include methanation of synthesis gas at 500° C., water-gas shift reactions at 200° C. to 400° C., coal gasification reactions at 700° C., and dimethyl ether production reactions at 250° C. Where steam is a reactant, current practice typically requires generating steam from water at the expense of large amounts of energy. Where steam is a product of a chemical reaction, current practice typically requires cooling and/or condensing the steam to remove it from other products of reaction. Cooling or condensing the steam may waste the energy content of the steam. While high-temperature reaction processes, such as those that occur at temperatures above 500° C., may be thermally integrated with other processes that utilize or provide heat energy through the use of heat exchangers, lower operating temperatures do not easily lend themselves to such integration.

Because steam is either a reactant or product of various types of chemical reactions, techniques are needed to efficiently add steam to and/or remove steam from the chemical reactions. More specifically, techniques are needed to efficiently add steam to or remove steam from chemical reactions in a controlled manner at or near the reaction temperature. This may help to control the extent of reaction and therefore the economics of the reaction.

Some polymeric membranes (e.g., Nafion) that are proton conductors also transport moisture. These membranes can potentially be used as water transport membranes. However, these membranes typically need to be humidified to function correctly and are limited to operating temperatures of about 80° C. Even so-called “high-temperature” polymer membranes are typically limited to operating temperatures of 120° C. Thus, these membranes are unable to operate in the temperature regimes of most chemical reactions, such as the chemical reactions described above.

In view of the foregoing, what is needed is a membrane that can selectively transport steam in the temperature range of about 100° C. to 400° C. Such a membrane would be of tremendous commercial interest since it could be used to add steam to or remove steam from various types of high-temperature chemical reactions.

### SUMMARY

The invention has been developed in response to the present state of the art and, in particular, in response to the problems and needs in the art that have not yet been fully solved by currently available apparatus and methods. Accordingly, the invention has been developed to provide apparatus and methods for adding steam to or removing steam from various types of chemical reactions. The features and advantages of the invention will become more fully apparent from the following description and appended claims, or may be learned by practice of the invention as set forth hereinafter.

Consistent with the foregoing, a high-temperature, steam-selective membrane for adding steam to or removing steam from various types of chemical reactions is disclosed herein. In one embodiment, such a membrane includes a polymer layer (a Nafion or sulfonated PEEK polymer layer, for example) exhibiting high selectivity to the transport of steam relative to other gas species. The polymer layer is sandwiched between substantially rigid porous layers that are steam permeable. The rigid porous layers substantially immobilize the polymer layer and reduce the tendency of the polymer layer to shrink and/or expand in response to changes in temperature or humidity. The rigid porous layers may also retain water to keep the polymer layer moist. The physical support and moisture retention provided by the rigid porous layers enable the polymer layer to operate in a temperature range of about 100° C. to 500° C.

In another aspect of the invention, a method for removing steam from a steam-laden gas stream is disclosed herein. In one embodiment, such a method includes providing a steam-selective membrane comprising a polymer layer (e.g., a Nafion or sulfonated PEEK polymer layer) sandwiched between substantially rigid steam-permeable porous layers. The method then conveys a steam-laden gas stream to a first side of the steam-selective membrane. The steam in the steam-laden gas stream is then selectively transported through the steam-selective membrane from the first side to a second side thereof, thereby generating a steam-depleted gas stream at the first side. The steam-depleted gas stream is then conveyed away from the first side.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 is a high-level, cross-sectional view of one embodiment of a high-temperature, steam-selective membrane in accordance with the invention;

FIG. 2 is a high-level, cross-sectional view of an alternative embodiment of the high-temperature, steam-selective membrane;

FIG. 3 is a high-level, cross-sectional view of a test fixture used to test one example of a high-temperature, steam-selective membrane in accordance with the invention;

FIG. 4 is a plot showing the variation in sensor temperature, relative humidity, and dew point as various parameters were adjusted during the testing process;

FIG. 5 is a plot showing the variation of the dew point on the downstream side of the membrane in relation to the amount of steam in the feed stream on the upstream side of the membrane, at an operating temperature of 150° C.;

FIG. 6 is a plot showing the variation in the amount of water flowing through the membrane relative to the amount of steam in the feed stream on the upstream side of the membrane, at an operating temperature of 150° C.;

FIG. 7 is a plot showing the variation of the dew point on the downstream side of the membrane in relation to the amount of steam in the feed stream on the upstream side of the membrane, at an operating temperature of 200° C.; and

FIG. 8 is a plot showing the variation of the amount of water flowing through the membrane relative to the amount of steam in the feed stream on the upstream side of the membrane, at an operating temperature of 200° C.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

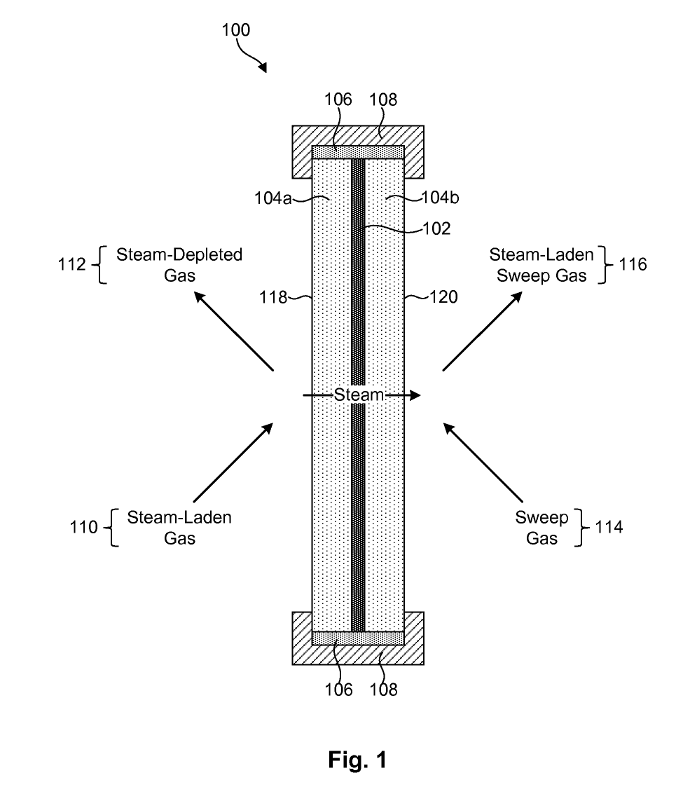

Referring to FIG. 1, a high-level, cross-sectional view of one embodiment of a high-temperature, steam-selective membrane 100 in accordance with the invention is illustrated. As previously mentioned, some conventional polymeric membranes that are proton conductors also transport moisture. These membranes can potentially be used as water transport membranes. However, such membranes are typically limited to operating temperatures of about 80° C., or 120° C. for so-called “high-temperature” polymer membranes. Thus, conventional membranes are unable to operate in the temperature regimes of many chemical reactions. Another issue is that conventional polymeric membranes need to be kept moist in order to transport water effectively. This can be a problem with high-temperature chemical reactions which may tend to dry out the membranes.

A high-temperature, steam-selective membrane 100 in accordance with the invention may address many of the above-described problems. In selected embodiments, a high-temperature, steam-selective membrane 100 includes a polymer layer 102 that is capable of selectively transporting steam relative to other gas species. For example the polymer layer 102 may be a Nafion layer 102, a sulfonated polyether ether ketone (PEEK) layer 102, or a polymer layer 102 exhibiting similar properties. For the purposes of this disclosure the terms “selectively” or “selectivity” are used to mean that the polymeric layer 102 primarily and/or substantially exclusively transports water or steam, although it does not preclude other trace elements or materials from passing through the polymer layer 102. For example, depending on the chemical reaction taking place and the gases that are present on either side of the membrane 100, some trace gases may pass through the polymer layer 102 in addition to steam or moisture. Thus, use of the terms “selectively” or “selectivity” does not necessarily preclude other trace elements or materials from passing through the polymer layer 102.

As shown in FIG. 1, the polymer layer 102 is sandwiched between two steam-permeable porous layers 104a, 104b. Thus, the porous layers 104a, 104b have open porosity sufficient to allow steam and other liquid or gaseous species to pass therethrough. In selected embodiments, the open porosity can range from 1 to 99 percent of the volume of the porous layers 104a, 104b and the pores can range in size from 1 nm to 1000 microns.

The porous layers 104a, 104b are substantially rigid in order to provide a physical support for the polymer layer 102. This allows the porous layers 104a, 104b to substantially immobilize the polymer layer 102 to counteract any tendency the polymer layer 102 may have to expand or contract in response to changes in temperature and/or humidity. The immobilization of the polymer layer 102 is one factor that enables the polymer layer 102 to be used in high-temperature applications. In selected embodiments, the steam-selective membrane 100 is configured to operate in a temperature range of about 100° C. to about 500° C.

In selected embodiments, a clamping mechanism 108 may be provided to keep the polymer layer 102 firmly clamped between the porous layers 104a, 104b. The clamping mechanism 108 may be embodied in many different forms and is not limited to the illustrated configuration. The clamping mechanism 108 may extend around all or part of the outer perimeter of the steam-selective membrane 100. In other embodiments, the porous layers 104a, 104b are adhered to the polymer layer 102. In yet other embodiments, both clamping and adhering the porous layers 104a, 104b to the polymer layer 102 may be used to substantially immobilize the polymer layer 102.

The porous layers 104a, 104b may be fabricated from various types of materials. These materials may be organic or inorganic, natural or synthetic. Examples of organic materials for fabricating the porous layers 104a, 104b may include but are not limited to plant fibers, cellulose, husk, coconut husk, plastics, polymers, or the like. Similarly, examples of inorganic materials for fabricating the porous layers 104a, 104b may include but are not limited to ceramics, metals, composites, fullerenes, nanotubes, or the like. The porous layers 104a, 104b may be of any desired size, shape, or thickness.

Where the porous layers 104a, 104b are fabricated from a ceramic material, the ceramic material may be obtained by casting a slip or purchased as a commercial item. The porous ceramic material may include but is not limited to titania, zirconia, yttria, alumina, magnesia, calcia, spinel, chromia, perovskites, silicon carbide, silicon nitride, titanium carbide, boron carbide, boron nitride, silica, corundum, aluminosilicate, bauxite, feldspar, mica, or the like. In selected embodiments, the porous ceramic material is a mixture of several different ceramic phases. In selected embodiments, the porous ceramic material is fabricated from a phosphate-bonded alumina composition where the phosphate bond is the result of adding phosphoric acid or aluminum phosphate to a ceramic slip. The porous ceramic material may be green, cured, or fired.

In selected embodiments, the porous ceramic material is designed to enable selective transport of certain species through its pores. In yet other embodiments, the pores of the porous ceramic material are infiltrated with various types of inorganic or organic catalysts that will convert species passing through the porous ceramic into more desirable forms.

The polymer layer 102 may be applied to the porous layers 104a, 104b in various different ways. For example, in one embodiment, the polymer layer 102 is a free-standing film (e.g., a free-standing Nafion film) that is placed adjacent to the porous layers 104a, 104b or adhered to the porous layers 104a, 104b. In another embodiment, the polymer layer 102 is applied to one or both porous layers 104a, 104b in the form of a paste, liquid, or other malleable mixture. The paste or liquid may be a solution containing a polymer (e.g., Nafion) in a specific solvent at a specific concentration. If desired, a vacuum may be applied to pull the paste or liquid into the pore structure of the porous layers 104a, 104b. The porous layers 104a, 104b may then be sandwiched together with the paste, liquid, or free-standing film therebetween.

In selected embodiments, an adhesive 106 is used to create a seal around an outer perimeter of the steam-selective membrane 100. This adhesive 106 may include but is not limited to a polymer adhesive, organic plant-derived adhesive, inorganic adhesive, ceramic adhesive, phosphate adhesive, or the like. The steam-selective membrane 100 may then be cured at a temperature ranging from about 0° C. to 400° C. to solidify the polymer layer 102 and/or the adhesive 106.

One benefit of placing porous layers 104a, 104b adjacent to the polymer layer 102 is that the porous layers 104a, 104b, depending on their pore size and structure, may keep water or moisture adjacent to the polymer layer 102. This may ensure that the polymer layer 102 stays sufficiently humidified to effectively transport water thereacross. Thus, the porous layers 104a, 104b may humidify the polymer layer 102 in addition to physically supporting the polymer layer 102.

As shown in FIG. 1, a high-temperature, steam-selective membrane 100 in accordance with the invention may be used to add steam to or remove steam from various types of chemical reactions. In general, steam-laden gas 110 (which may include a mixture of several gases) may be conveyed to a first side 118 of the steam-selective membrane 100. All or part of the steam in the steam-laden gas 110 may be removed and transported through the steam-selective membrane 100. This will generate steam-depleted gas 112 which may be conveyed away from the steam-selective membrane 100. Meanwhile, a sweep gas 114 may be conveyed to a second side 120 of the steam-selective membrane 100. The sweep gas 114 may mix with the steam to generate steam-laden sweep gas 116. This steam-laden sweep gas 116 may then be conveyed away from the second side 120 of the steam-selective membrane 100.

For example, assume that the steam-selective membrane 100 is used in a steam reformation process wherein steam is reacted with methane to produce carbon monoxide and hydrogen at temperatures above 600° C. Assume that the carbon monoxide and hydrogen contain residual steam after the reaction. In such a case, the carbon monoxide, hydrogen, and steam (as well as other gases such as nitrogen, oxygen, carbon dioxide, etc.) constitute the steam-laded gas stream 110 that is conveyed to the first side 118 of the steam-selective membrane 100. The steam may then be removed from the gas stream 110 by transporting it through the steam-selective membrane 100. In some cases, trace amounts of gas such as hydrogen gas may be transported through the membrane 100 along with the steam. Transporting steam through the membrane 100 will generate steam-depleted gas 112 which contains carbon monoxide, hydrogen, nitrogen, oxygen, carbon dioxide, etc. This steam-depleted gas 112 may then be conveyed away from the steam-selective membrane 100.

Meanwhile, a sweep gas 114 may be conveyed to the second side 120 of the steam-selective membrane 100 where it may mix with the steam to generate the steam-laden sweep gas 116. The steam-laden sweep gas 116 may then be conveyed away from the second side 120 of the steam-selective membrane 100. If desired, any residual hydrogen or other gases may be recovered from the sweep gas 116 by condensing the steam contained in the sweep gas 116.

In another example of the above-described process, assume that the steam-selective membrane 100 is used in a Fischer-Tropsch process wherein hydrogen and carbon monoxide are reacted at 250° C. to generate hydrocarbons and steam. In such a process, the hydrocarbons and steam will supply the steam-laded gas 110 that is conveyed to a first side 118 of the steam-selective membrane 100. The steam may then be removed from the gas stream 110 and transported through the steam-selective membrane 100. This will generate steam-depleted gas 112 which contains hydrocarbons. The steam-depleted gas 112 may then be conveyed away from the steam-selective membrane 100. In a similar manner, a sweep gas 114 may be conveyed to the second side 120 of the steam-selective membrane 100 to carry steam away from the second side 120.

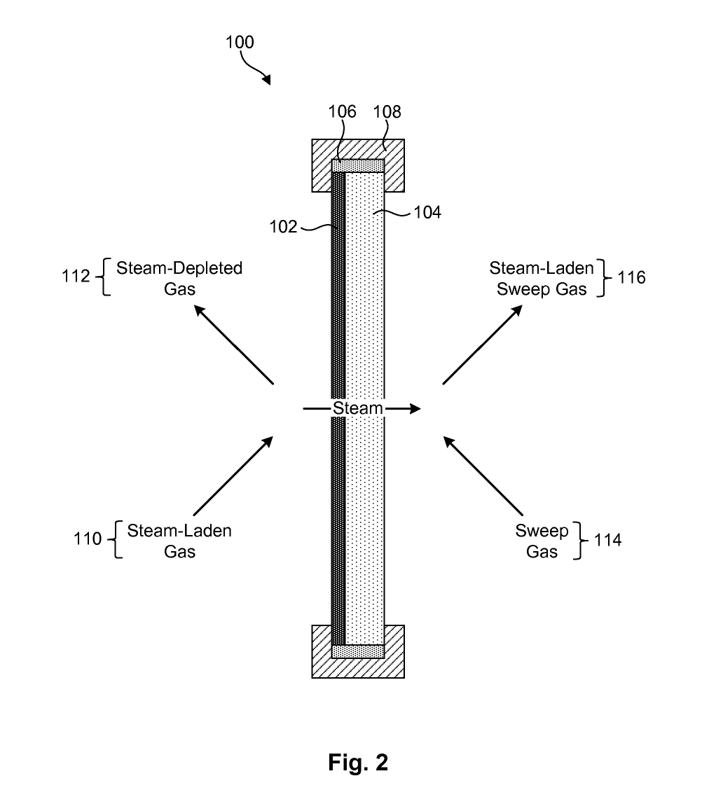

Referring to FIG. 2, a high-level, cross-sectional view of an alternative embodiment of a high-temperature, steam-selective membrane 100 in accordance with the invention is illustrated. In this embodiment, the polymer layer 102 is placed adjacent to a single porous layer 104 as opposed to being sandwiched between two porous layers. The porous layer 104 may provide structural support for the polymer layer 102 as well as keep the polymer layer 102 moist. FIG. 2 also shows an adhesive 106 and clamping mechanism 108 although these may not be necessary in all embodiments.

In selected embodiments, the polymer layer 102 is a free-standing film that is placed adjacent to the porous layer 104 and securely adhered thereto. In another embodiment, the polymer layer 102 is applied to the porous layer 104 in the form of a paste or liquid. Ideally, the paste or liquid will infiltrate the pores of the porous layer 104 to increase the bond therebetween. The assembly 100 may then be cured to solidify the polymer layer 102. Because the polymer layer 102 is bonded to the porous layer 104, the porous layer 104 may counteract any tendency of the polymer layer 102 to expand and/or contract in response to changes in temperature and/or humidity.

In selected embodiments, the polymer layer 102 and porous layer 104 form two distinct layers. In other embodiments, the polymer layer 102 and porous layer 104 form two distinct layers but intermingle or intermix at the interface (such as where the polymer layer material infiltrates the porous layer 104). In yet other embodiments, the polymer layer 102 and porous layer 104 form a single intermingled, integrated layer. That is, the polymer layer 102 substantially entirely infiltrates the porous layer 104 or a portion of the porous layer 104.

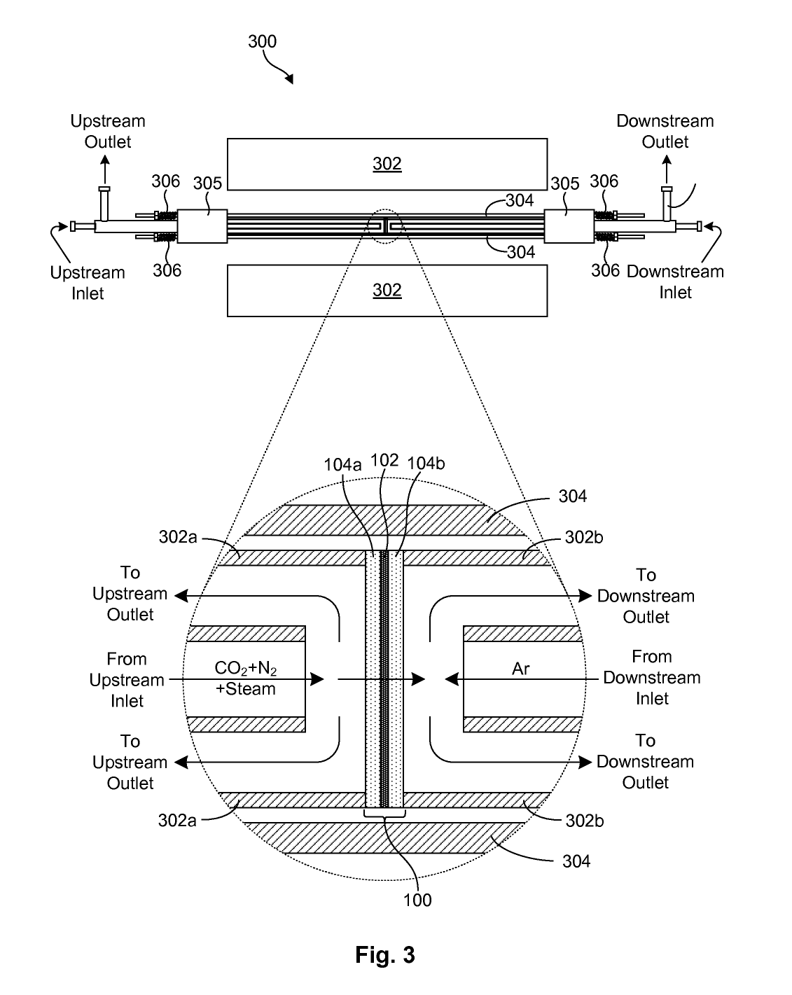

Referring to FIG. 3, a high-level, cross-sectional view of a test fixture 300 used by the instant inventor to test one example of a high-temperature, steam-selective membrane 100 in accordance with the invention is illustrated. The test fixture 300 was used to test the performance of a steam-selective membrane 100 comprising a Nafion layer 102 sandwiched between two porous ceramic layers 104a, 104b. The porous ceramic layers 104a, 104b were fabricated from a fired ceramic castable nanomaterial which consisted of alumina, phosphoric acid, water, and minor additives. The circumference of the steam-selective membrane 100 was sealed using the same ceramic castable nanomaterial. The assembly 100 was then cured in an oven at 150° C. for 24 hours.

Steam permeation tests were then carried out using the specially designed test fixture 300. More specifically, the steam-selective membrane 100 was secured at the ends of two alumina tubes 302a, 302b held together by a spring load generated by rods 304, blocks 305, and springs 306. The test rig 300 was then placed in the hot zone of a furnace 302. A thermocouple was placed near the steam-selective membrane 100 to monitor its temperature. Heat tapes were used to prevent condensation along the upstream and downstream channels. The steam percentage in the gas mixture routed into the upstream inlet was controlled by the temperature of a steam bubbler. Vaisala humidity sensors were used to measure the relative humidity and dew point of upstream and downstream gases. When the furnace 302 was heated to 100° C., steam carried by CO₂ and N₂ was introduced into the upstream inlet. Argon gas, used as the sweep gas, was introduced into the downstream inlet. After the sweep gas passed through the text fixture 300 and exited through the downstream outlet, the sweep gas was bubbled through ice water to condense the steam. The remaining sweep gas composition was then characterized by a Micro GC gas chromatograph.

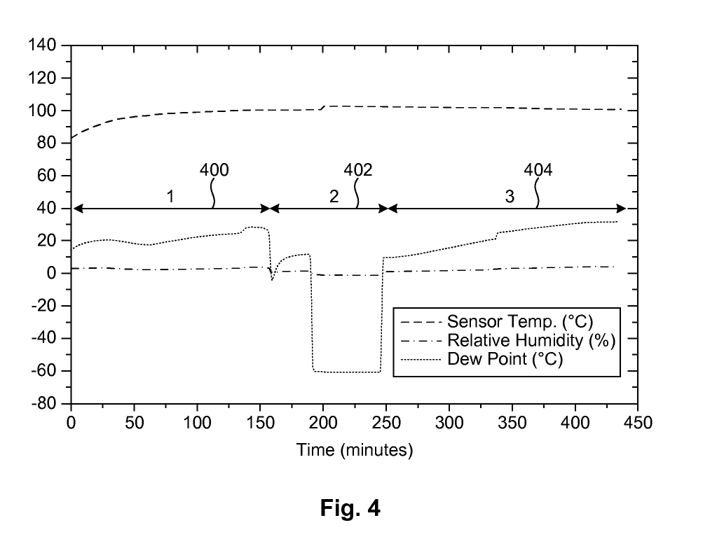

A test using the test fixture 300 was conducted as follows: A gas mixture containing CO₂, N₂, and steam was routed into the upstream inlet. A sweep gas consisting of argon gas was routed into the downstream inlet. The following steps were then performed over three separate time periods 400, 402, 404 as documented in FIG. 4:

First, during a first time period 400, the furnace temperature was heated to approximately 90° C. and the bubbler temperature was varied between 179° F. and 203° F., thereby varying the amount of steam in the gas mixture on the upstream side from about 50 to about 80 percent. The flow rate of the argon gas into the downstream inlet was set at 2 ml/min. The resulting sensor temperature (which measured the temperature of the membrane 100), relative humidity, and dew point associated with the outgoing gas stream from the downstream outlet during the time period 400 are illustrated in FIG. 4.

Second, during a second time period 402, the flow rate of the argon sweep gas was increased to 10 ml/min in order to obtain a gas sample at the downstream outlet for GC characterization. After a gas sample was obtained, the flow rate was readjusted to 2 ml/min. After 30 minutes, the flow rate was changed to 30 ml/min in order to obtain another gas sample at the downstream outlet for GC characterization. The resulting sensor temperature, relative humidity, and dew point associated with the outgoing gas stream from the downstream outlet during the time period 402 are illustrated in FIG. 4.

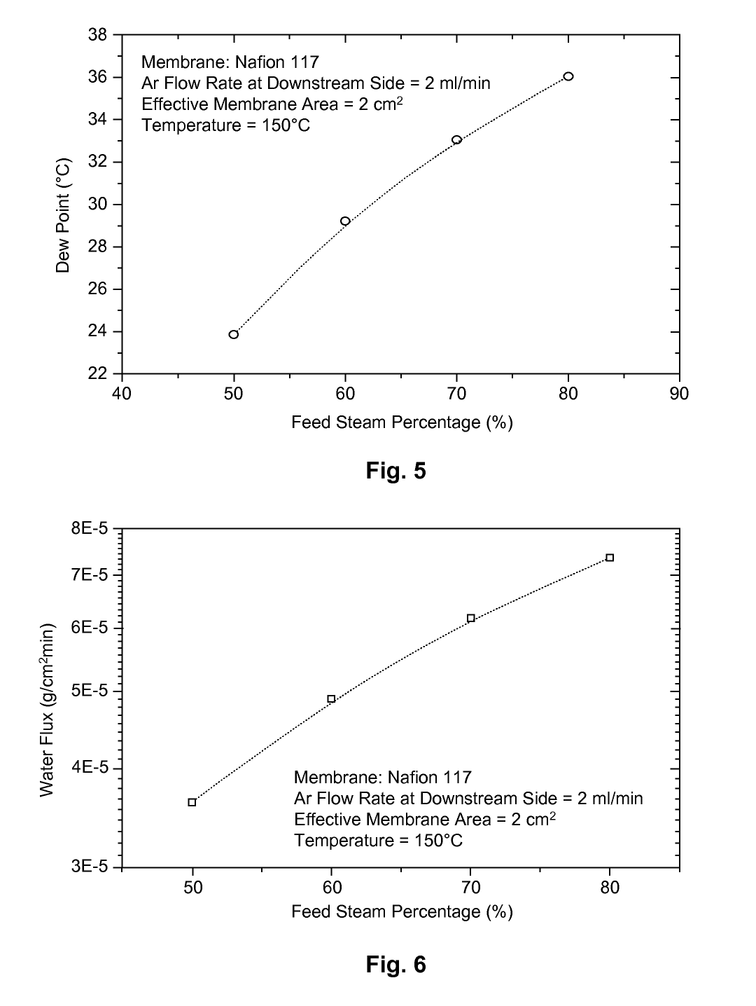

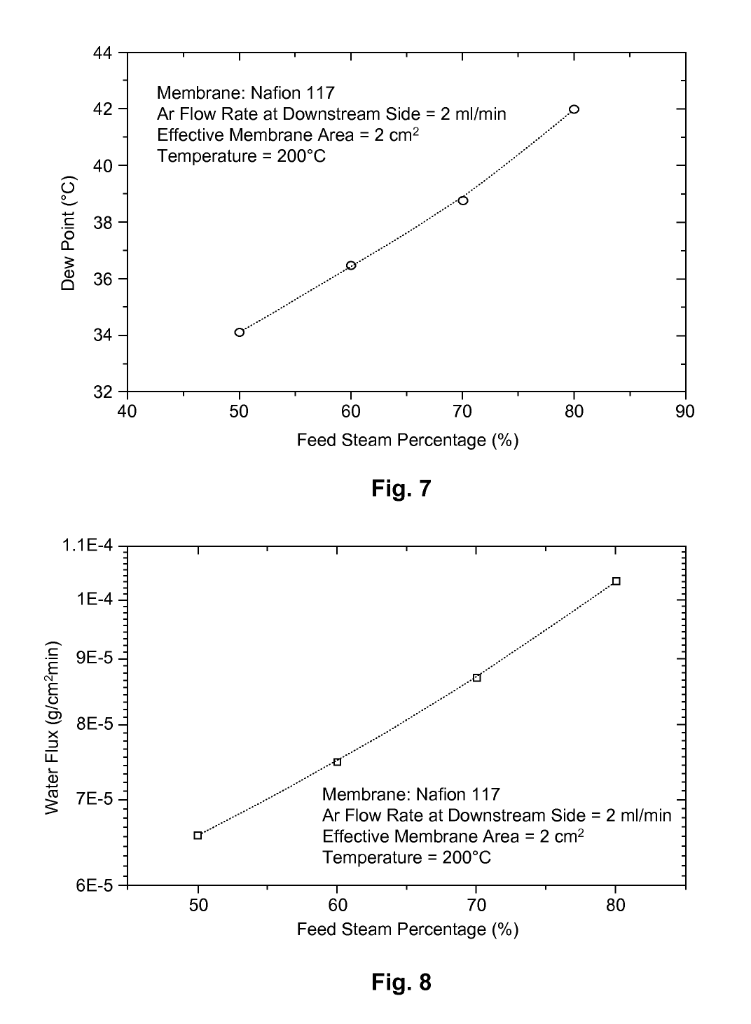

Third, during a third time period 404, the flow rate of the argon sweep gas was reduced to zero to allow the Nafion membrane to “recover” on the down stream side of the membrane 100. When the dew point reached 20° C., the flow rate of the argon sweep gas was adjusted to 2 ml/min. The resulting sensor temperature, relative humidity, and dew point associated with the outgoing gas stream from the downstream outlet during the time period 404 are illustrated in FIG. 4. The furnace temperature was then increased to 150° C. (where the measurements in FIGS. 5 and 6 were obtained) and then to 200° C. (where the measurements in FIGS. 7 and 8 were obtained). The bubbler temperature varied between 179° F. and 203° F., thereby varying the amount of steam in the gas mixture on the upstream side from about 50 to about 80 percent.

The results of the test conducted above show that steam is transported through the steam-selective membrane 100 at both 90° C. and 150° C. No CO₂ or N₂ was detected on the downstream side of the steam-selective membrane 100. As shown in FIG. 5, at 150° C., the dew point increased from 24° C. to 36° C. as the steam percentage on the upstream side increased from 50 to 80 percent.

It should be noted that the flow rate of the argon sweep gas on the downstream side of the membrane 100 should be carefully controlled to prevent the formation of a thin impermeable skin at the membrane/gas interface. This is especially important for Nafion 117, which is 183 μm thick. The thicker the membrane, typically the easier the formation of the “skin.”

The water flux through the membrane 100 may be calculated using the following equation:

$$Flux = ( \frac{P ( T )}{1 - P ( T )} ) ( \frac{{PQ}_{in}}{{A}_{eff} RT} ) g \text{/} {cm}^{2} min$$

where P(T) is the steam percentage on the downstream side of the membrane 100 deduced from the dew point, Qᵢₙ is the carrier gas flow rate on the downstream side, A_{eff} is the effective membrane area, P is the pressure, T is the temperature, and R is the gas constant. Using this equation, the water flux through the steam-selective membrane 100 at 150° C. increased from 3.62×10⁻⁵ g/cm² min to 7.35×10⁻⁵ g/cm² min as the steam percentage on the upstream side increased from 50 to 80 percent, as shown in FIG. 6.

The same tests were then performed on the same steam-selective membrane 100 at 200° C. As shown in FIG. 7, at 200° C., the dew point increased from 34° C. to 42° C. as the steam percentage on the upstream side increased from 50 to 80 percent. As shown in FIG. 8, at 200° C., the water flux through the steam-selective membrane 100 at 150° C. increased from 6.56×10⁻⁵ g/cm² min to 1.04×10⁻⁴ g/cm² min as the steam percentage on the upstream side increased from 50 to 80 percent, as shown in FIG. 8.

The present invention may be embodied in other specific forms without departing from its basic principles or essential characteristics. The described embodiments are to be considered in all respects as illustrative and not restrictive. The scope of the invention is, therefore, indicated by the appended claims rather than by the foregoing description. All changes which come within the meaning and range of equivalency of the claims are to be embraced within their scope.

1. A high-temperature, steam-selective membrane, the steam-selective membrane comprising:
a polymer layer exhibiting a high selectivity to the transport of steam relative to other gas species, the polymer membrane sandwiched between substantially rigid porous layers that are steam permeable.

2. The steam-selective membrane of claim 1, wherein the polymer layer comprises Nafion.

3. The steam-selective membrane of claim 1, wherein the polymer layer comprises sulfonated polyether ether ketone (PEEK).

4. The steam-selective membrane of claim 1, wherein the substantially rigid porous layers are configured to keep the polymer layer moist.

5. The steam-selective membrane of claim 1, wherein the substantially rigid porous layers comprise one of porous ceramic layers and porous metal layers.

6. The steam-selective membrane of claim 1, wherein the polymer layer is configured to operate in the temperature range of about 100° C. to about 500° C.

7. The steam-selective membrane of claim 1, wherein the polymer layer is applied to at least one of the substantially rigid porous layers as one of a liquid and a paste, and then cured to form a substantially solid polymer layer.

8. The steam-selective membrane of claim 1, wherein the polymer layer is applied to at least one of the substantially rigid porous layers as a free-standing film.

9. The steam-selective membrane of claim 1, wherein the steam-selective membrane is cured to achieve bonding between the polymer layer and the substantially rigid porous layers.

10. The steam-selective membrane of claim 1, further comprising a clamping mechanism to clamp the polymer layer between the substantially rigid porous layers.

11. A method for removing steam from a steam-laden gas stream, the method comprising:
providing a steam-selective membrane comprising a steam-selective polymer layer sandwiched between rigid steam-permeable porous layers;
conveying a steam-laden gas stream to a first side of the steam-selective membrane;
transporting steam in the steam-laden gas stream through the steam-selective membrane from the first side to a second side of the steam-permeable membrane, thereby generating a steam-depleted gas stream at the first side; and
conveying the steam-depleted gas stream away from the first side.

12. The method of claim 11, further comprising conveying a sweep gas to the second side of the steam-selective membrane.

13. The method of claim 12, further comprising conveying the steam away from the second side with the sweep gas.

14. The method of claim 11, wherein the steam-selective polymer layer comprises at least one of Nafion and sulfonated polyether ether ketone (PEEK).

15. The method of claim 11, further comprising using the rigid steam-permeable porous layers to maintain moisture in the steam-selective polymer layer.

16. The method of claim 11, wherein the rigid steam-permeable porous layers comprise one of porous ceramic layers and porous metal layers.

17. The steam-permeable membrane of claim 11, wherein the temperature of the steam-laden gas stream ranges from about 100° C. to about 500° C.

18. A high-temperature, steam-selective membrane, the steam-selective membrane comprising:
a polymer layer exhibiting a high selectivity to the transport of steam relative to other gas species, the polymer layer being physically adhered to at least one substantially rigid steam-permeable porous layer.

19. The steam-selective membrane of claim 18, wherein the polymer layer comprises at least one of Nafion and sulfonated polyether ether ketone (PEEK).

20. The steam-selective membrane of claim 18, wherein the at least one substantially rigid steam-permeable porous layer is one of a porous ceramic layer and a porous metal layer.

21. The steam-selective membrane of claim 18, wherein the polymer layer operates in a temperature range of about 100° C. to about 500° C.

22. The steam-selective membrane of claim 18, wherein the polymer layer is applied to the at least one substantially rigid steam-permeable porous layer as one of a liquid and a paste, and then cured to form a substantially solid polymer layer.

23. The steam-selective membrane of claim 18, wherein the polymer layer is applied to the at least one substantially rigid steam-permeable porous layer as a free-standing film.

24. The steam-selective membrane of claim 18, wherein the steam-selective membrane is cured to achieve bonding between the polymer layer and the at least one substantially rigid steam-permeable porous layer.

25. A high-temperature, steam-selective membrane, the steam-selective membrane comprising:
a polymer layer exhibiting a high selectivity to the transport of steam relative to other gas species, the polymer layer being physically adhered to at least one substantially rigid steam-permeable porous layer comprising one of a porous ceramic layer and a porous metal layer;
wherein the polymer layer comprises at least one of Nafion and sulfonated polyether ether ketone (PEEK);
wherein the polymer layer operates in a temperature range of about 100° C. to about 500° C.; and,
wherein the steam-selective membrane is cured to achieve bonding between the polymer layer and the at least one substantially rigid steam-permeable porous layer.

26. The steam-selective membrane of claim 25, wherein the polymer layer is applied to the at least one substantially rigid steam-permeable porous layer as one of a liquid and a paste, and then cured to form a substantially solid polymer layer.

27. The steam-selective membrane of claim 25, wherein the polymer layer is applied to the at least one substantially rigid steam-permeable porous layer as a free-standing film.
